(19) United States
(12) Patent Application Publication
(10) Pub. No.: US 2010/0129509 A1
(43) Pub. Date: May 27, 2010

(54) NATURAL PRODUCT EXTRACTION

(76) Inventors: Heribert Dierkes, Hagen (DE); Volkmar Steinhagen, Hagen (DE); Michael Bork, Dortmund (DE); Christoph Lütge, Unna (DE); Zeljko Knez, Maribor (SI)

Correspondence Address: COLLARD & ROE, P.C., 1077 NORTHERN BOULEVARD, ROSLYN, NY, 11576, US

(21) Appl. No.: 12/452,723

(22) PCT Filed: Jun. 13, 2008
(86) PCT No.: PCT/EP2008/004752

§ 371 Date: Jan. 19, 2010

(30) Foreign Application Priority Data
Jul. 20, 2007 (DE) 10 2007 033907.2

(51) Int. Cl. A23L 1/28; A23L 1/223; A23L 1/221

(52) U.S. Cl. 426/318; 426/312; 426/429; 426/431; 426/437; 426/430

(57) ABSTRACT

In a method for extracting products of value from animal or vegetable starting material, a solution is to be created, with which extraction is improved, with regard to both the yield and separation of natural products to be extracted, and management of the method.

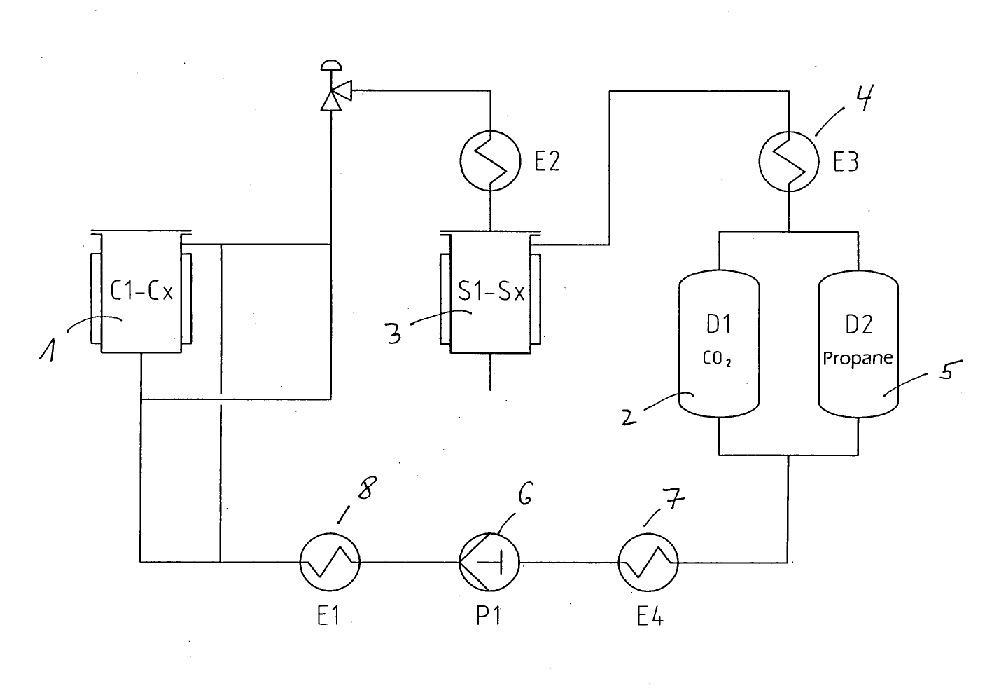

This is achieved in that soluble constituents are extracted from the starting material in a first extraction step, using CO₂, and subsequently, in a second extraction step, other constituents are extracted with compressed hydrocarbons.

The invention is directed at a method for extracting products of value from animal or vegetable starting material.

High-pressure extraction is one possibility for obtaining products from animal or vegetable material, particularly with the goal of protecting the environment and saving energy. For example, WO 2007/017106-A1, which relates to a method for obtaining natural oils from vegetable components, or WO 2007/017105-A2, which describes the extraction of fruit waxes, or, for example, DE-102 00 226-A1, which has high-pressure flushing extraction as its content, belong to the state of the art. Two-stage extraction methods are described, for example, in DE 31 14 593 C1 or EP 0 711 508 A1.

While the methods of procedure according to the state of the art demonstrate good results, in part, it has been shown that extraction and separation of specific substances is not always possible in satisfactory manner, so that the task of the present invention consists in improving extraction, with regard to both the yield and separation of natural products to be extracted, and management of the method.

This task is accomplished, according to the invention, with a method of the type indicated initially, in that soluble constituents are extracted from the starting material in a first extraction step, using CO₂, and subsequently, in a second extraction step, other constituents are extracted with compressed hydrocarbons.

It has been shown that two-stage extraction, first with CO₂ and then with compressed hydrocarbons, leads to optimal results.

Embodiments of the invention are evident from the dependent claims. In this connection, it can be practical, according to the invention, to use a mixture of CO₂ and a polar entraining agent (water, alcohols, ketones, or mixtures) in the first extraction step.

In this connection, the second extraction step can be carried out, according to the invention, with fluorohydrocarbons or chlorohydrocarbons as extraction agents, for example, but here, mixtures of CO₂ and hydrocarbons can also be used, as the invention also provides in a further embodiment.

In the second extraction step, as well, mixtures of CO₂ and polar entraining agents, such as water, alcohols, ketones, or mixtures of them, can be used as the extraction agent.

Another embodiment of the method of procedure according to the invention consists in that the first extraction step and/or the second extraction step is/are carried out in multiple stages, in each instance, and that fractionating separation is carried out, in the individual steps, on the basis of different pressures or different temperatures.

It can be advantageous if separation of the extracts from the solvents takes place by means of a change in pressure and/or temperature, whereby in a further embodiment of the invention, it can be provided that separation of the individual solvents and entraining agents takes place by means of distillation or rectification and/or is carried out using a membrane.

Separation of the extraction extracts from the entraining agents can be carried out, for example, in a special device within the method provided for this purpose.

Another embodiment of the invention consists in that products of ocean fauna or ocean flora are used as the starting material, whereby the invention is not restricted to this area of use, as the following examples document:

### EXAMPLE 1

0.5 kg of sweet paprika (Capsicun annuum) was filled into the extractor and extracted at 90 bar and 60° C. for 3 hours (solvent/raw material ratio of 40 kg/kg). In the separator, which was operated at 50 bar and 40° C., 10 g paste-like product (waxes that contain emulsifiers; aromatic components, and water) were collected. In the subsequent step, extraction with propane was performed, during which carotenoids were collected (capsanthin, capsorubin, beta-carotene, beta-cryptoxanthin, lutein, violaxanthin, zeaxanthin). Extraction was performed at 150 bar and 40° C., solvent/raw material ratio 4 kg propane/kg raw material. The yield was 3% (w/w), but also depends on the content of these compounds in the starting materials.

### EXAMPLE 2

0.5 kg of pungent paprika (Capsicun frutescens) was filled into the extractor and extracted at 150 bar and 60° C. for 2 hours (solvent/raw material ratio of 45 kg/kg). In the first separator, which was operated at 90 bar and 40° C., 9 g (1.8% w/w) of pale paste-like product containing capsaicinoids was collected. In the second separator, which was operated at 50 bar and 40° C., 10 g paste-like product (fatty oils that contain emulsifiers, and water) were collected. In the subsequent step, extraction with propane was performed, during which carotenoids were collected (capsanthin, capsorubin, beta-carotene, beta-cryptoxanthin, lutein, violaxanthin, zeaxanthin). Extraction was performed at 150 bar and 40° C., solvent/raw material ratio 4 kg propane/kg raw material. The yield was 3% (w/w) but also depends on the content of these components in the starting materials.

### EXAMPLE 3

0.5 kg of tomato powder (Lycoperscom esculentum) was filled into the extractor and extracted at 200 bar and 60° C. for 2 hours (solvent/raw material ratio of 35 kg/kg). In the separator, which was operated at 40 bar and 40° C., 12 g (2.4%) of pale paste-like product (containing fats, waxes and water) was obtained. In the subsequent step, extraction with propane was performed, during which carotenoids were collected (carotene and carotenoids—mostly lycopene and beta-carotene). Extraction was performed at 150 bar and 40° C., solvent/raw material ratio 4 kg propane/kg raw material. The yield of propane extraction is from 1 to 2% (w/w) and depends on the content of these components in the starting materials.

### EXAMPLE 4

0.5 kg of powder of Tagetes erecta was filled into the extractor and extracted at 250 bar and 60° C. for 2 hours (solvent/raw material ratio of 50 kg/kg). In the separator, which was operated at 40 bar and 40° C., 10 g of pale paste-like product (containing fats, waxes and water) was collected. In the subsequent step, extraction with propane was performed, during which carotenoids were collected. Extraction was performed at 150 bar and 60° C., whereby the ratio of the solvent to the raw material amounts to 4 kg propane/kg raw material. The yield of propane extraction depends on the content of these compounds in the starting materials and is between 1 and 2% (w/w).

### EXAMPLE 5

0.5 kg of seafood meal was filled into the extractor and extracted at 150 bar and 60° C., with pure propane, up to a ratio of solvent to raw material of 6.5 kg/kg. In a separator, which was operated at 40 bar and 40° C., dark red oil was collected. The oil does not contain any water.

### EXAMPLE 6

0.5 kg of seafood meal was filled into the extractor and extracted at 850 bar and 60° C., with pure CO₂, up to a ratio of solvent to raw material of 15 kg/kg. In the separator, which was operated at 40 bar and 40° C., light, red oil and water were collected. The yield of this extraction stage (CO₂) was 8 to 10%, depending on the source of the fishmeal.

In the subsequent step, that of extraction with propane, phospholipids were extracted and collected. Extraction was performed at 150 bar and 60° C., whereby the ratio of the solvent to the raw material was 2.8 kg propane/kg raw material. The yield of propane extraction depends on the content of these constituents in the starting materials, and is usually between 2 to 4% (w/w).

### EXAMPLE 7

0.5 kg of soy meal was filled into the extractor and extracted at 150 bar and 60° C., with pure propane, up to a ratio of solvent to raw material of 12 kg/kg. In a separator operated at 40 bar and 40° C., oil was collected. The oil does not contain any water. Extraction kinetics showed that a ratio of the solvent to the raw material of at least 12 kg/kg is necessary to obtain the highest yields (about 14% w/w).

### EXAMPLE 8

0.5 kg of soy meal was filled into the extractor and extracted at 1000 bar and 80° C., with pure CO₂, up to a ratio of solvent to raw material of 40 kg/kg. In a separator operated at 40 bar and 40° C., oil and water were collected. The yield of this extraction step (CO₂) was about 17%, depending on the source of the soy meal.

In the subsequent step of extraction with propane, phospholipids were extracted and collected. Extraction was performed at 150 bar and 60° C., whereby the ratio of the solvent to the raw material was 4.4 kg propane/kg raw material. The yield of propane extraction depends on the content of these constituents in the starting materials, and is usually 10% (w/w).

Other characteristics, details, and advantages of the invention are evident from the following description and the drawing. This drawing, in the single FIGURE, shows the method of procedure according to the invention, as a flow chart.

The product to be treated, for example powdered or pellet-form solids, is introduced into one or more extractors, indicated in general with 1, and first, CO₂ from a first supply container 2 is applied to it. The extraction product contained in the gas is passed to a separator, indicated in general with 3, and separated there. The CO₂ is recovered and passed back to the supply container 2 by way of a heat exchanger 4.

In the second method step, propane is passed to the extractor or multiple extractors 1 from a supply container 5, in order to undertake a further extraction. The feed of the extraction agents, in each instance, takes place by way of at least one pump 6, impacting additional heat exchangers 7 and 8.

The present diagram only represents an example and is greatly simplified. As has already been mentioned, multiple extraction containers can be provided, as can multiple separators, depending on the product used and depending on the desired products of value that are to be extracted.

1. Method for extracting products of value from animal or vegetable starting material, wherein
soluble constituents are extracted from the starting material in a first extraction step, using CO₂, and subsequently, in a second extraction step, other constituents are extracted with compressed hydrocarbons.

2. Method according to claim 1, wherein
in the first extraction step, a mixture of CO₂ and a polar entraining agent (water, alcohols, ketones, or mixtures) is used.

3. Method according to claim 1, wherein
in the second extraction step, fluorohydrocarbons or chlorohydrocarbons are used as the extraction agent.

4. Method according to claim 1, wherein
in the second extraction step, a mixture of CO₂ and hydrocarbons is used.

5. Method for extracting products of value from animal or vegetable starting material, particularly according to claim 1, wherein
in the second extraction step, a mixture of CO₂ and a polar entraining agent (water, alcohols, ketones, or mixtures) is used as the extraction agent.

6. Method according to claim 1, wherein
the first extraction step and/or the second extraction step is/are carried out in multiple stages, in each instance, and wherein fractionating separation is carried out, in the individual steps, on the basis of different pressures or different temperatures.

7. Method according to claim 1, wherein
separation of the extracts from the solvents takes place by means of a change in pressure and/or temperature.

8. Method according to claim 1, wherein
separation of the individual solvents and entraining agents takes place by means of distillation or rectification and/or is carried out using a membrane.

9. Method according to claim 1, wherein
separation of the extracts from the entraining agents takes place in at least one device.

10. Method according to claim 1, wherein
products of ocean fauna or ocean flora are used as the starting material.
